(19) United States
(12) Patent Application Publication
(10) Pub. No.: US 2018/0306004 A1
(43) Pub. Date: Oct. 25, 2018

(54) Hot Rods

(71) Applicant: John M. Raglin, Horseshoe Bay, TX (US)

(72) Inventor: John M. Raglin, Horseshoe Bay, TX (US)

(21) Appl. No.: 15/496,564

(22) Filed: Apr. 25, 2017

(51) Int. Cl. E21B 36/04; E21B 17/00; H05B 6/10

(52) U.S. Cl. CPC E21B 36/04; E21B 43/127; H05B 6/10; E21B 17/00

(57) ABSTRACT

System and methods are described that help to inhibit the formation of paraffin or wax within an oil well or pumping mechanism. Magnets can be integrated into a rod within the well tubing. The tubing can comprise metal portions such as bands or coils that can experience an induced electrical current as the rod magnets pass back and forth during pump operation. The induced electric current raises the temperature of fluids and materials in the well, inhibiting paraffin formation.

### TECHNICAL FIELD

The present disclosure is directed to oil producing wells and more particularly to rods within the well.

### BACKGROUND OF THE INVENTION

Oil dynamics change on producing oil wells as oil moves from subsurface to surface. These dynamic variables include temperature, pressure, gas saturation, and many others. Bottom-hole temperatures can range from 90° F. up to 500° F. dependent upon reservoir type, geographical area and depth. Temperature change from bottom to surface can have an adverse effect on oil behavior and property as it moves upward. The highest temperature state that the oil will see is generally at the maximum vertical depth of the well. As the oil travels up the tubing to be produced at surface, cooling takes place, and paraffin or wax can form.

### BRIEF SUMMARY OF THE INVENTION

One possible embodiment of the current disclosure can comprise a well for pumping oil, comprising: a casing disposed underground; a tubing disposed within the casing and comprising a first plurality of sections comprising a first material; and a rod disposed within the tubing and comprising a second plurality of sections comprising a second material, the rod configured to be moved up and down during operation of the well, wherein the second plurality of sections pass through the first plurality of sections and induce an electric current in at least one of the first or second materials, the electric current generating heat in response to the resistance of the first or second material thereby raising a temperature within the well.

Another possible embodiment under the present disclosure can comprise a well for pumping oil, comprising: a casing disposed underground; a tubing disposed within the casing and comprising one or more metal bands extending around the tubing; and a rod disposed within the tubing and comprising one or more magnets, the rod configured to be moved up and down during operation of the well, wherein the one or more magnets pass through the one or more metal bands during operation of the well and induce an electric current in the one or more metal bands, the electric current generating heat in response to the resistance of the metal bands thereby raising a temperature within the well.

Another possible embodiment under the present disclosure can comprise a method of constructing an oil well, comprising: providing a casing extending into the ground; providing a tubing within the casing, the tubing comprising one or more metal portions extending around the tubing; and providing a rod within the tubing that is configured to be moved up and down during operation of the well, the rod comprising one or more magnets, wherein the one or more magnets pass through the one or more metal portions during operation of the well and induce an electric current in the one or more metal portions, the electric current generating heat in response to the resistance of the one or more metal portions and thereby operable to raise a temperature within the well.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawings, in which:

FIG. 1 is a diagram of a possible embodiment under the present disclosure.

FIG. 2 is a diagram of a possible embodiment under the present disclosure.

FIG. 3 is a diagram of a possible embodiment under the present disclosure.

FIGS. 4A-4B are diagrams of possible embodiments under the present disclosure.

FIG. 5 is a diagram of a possible embodiment under the present disclosure.

FIGS. 6A-6B are flow-chart diagrams of possible method embodiments under the present disclosure.

FIGS. 7A-7B are diagrams of possible embodiments under the present disclosure.

FIG. 8 is a diagram of a possible embodiment under the present disclosure.

FIG. 9 is a diagram of a possible embodiment under the present disclosure.

FIG. 10 is a diagram of a possible embodiment under the present disclosure.

FIGS. 11A-11D are diagrams of possible embodiments under the present disclosure.

FIG. 12 is a diagram of a possible embodiment under the present disclosure.

FIG. 13 is a diagram of a possible embodiment under the present disclosure.

### DETAILED DESCRIPTION OF THE INVENTION

Oil dynamics in oil producing wells can create problems as oil cools the higher it rises in the well. The highest temperature state that the oil will see is at the maximum vertical depth of the well. Cooling takes place as the oil travels up the tubing. Commonly and dependent upon oil properties and well depths the oil can start to solidify into paraffin or wax when it reaches a certain depth and/or temperature (cloud point). Overtime and as the well produces, continual precipitation of paraffin can cause major production problems at surface in flowlines or in the downhole tubing production string. Wells produced by the artificial lift method of rod and beam are particularly problematic as a rod string is placed into the tubing to reciprocate the downhole pump assembly. Overtime, the paraffin buildup starts to interfere with fluid movement through the tubing as well as acting to slow or totally stop the reciprocating motion of the rod string, leading to well failure and expensive maintenance.

Several techniques for paraffin mitigation include: chemical treating to stop precipitation and hot oil or water injection to melt existing paraffin. Chemical injection tends to help mitigate paraffin, but is costly and difficult to get in the proper place to mitigate the problem. The percentage of success is relatively low. Hot oil or water treatment is also costly, but effective only to melt existing paraffin and is in no way preventative. This effort is also known, over time, to damage wellbores and reservoirs, as the heavy ends of the oil are continually circulated to bottom and end up as tar, restricting fluid flow into the well.

One embodiment under the present disclosure, and solution to the problems described above, comprises rods, “hot rods,” or magnetic rods, that are able to change the temperature profile of the oil as it moves up the wellbore toward the surface. The result is that the oil is not allowed to cool to the critical temperature at which paraffin forms.

The present teachings draw from the ability of magnets and coils to generate electric power. The relation between the conversion of mechanical energy into heat energy is governed by Lenz's Law. This law states that a magnet moving past or through a conductive structure will generate electric currents which then create a magnetic field that is in opposition to the field that induced them. The currents generated in the process generate I²R losses dissipated as heat.

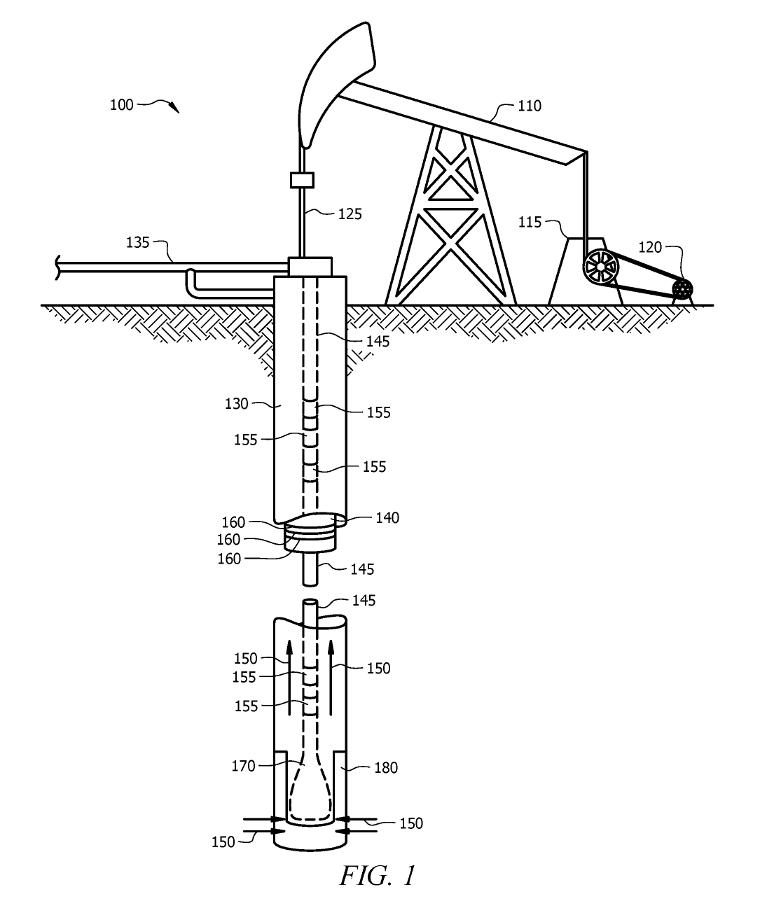

One embodiment can be seen in FIG. 1. In this embodiment, coils 160 reside on the outside of the tubing string 140, and the magnets 155 are placed in the rod string 145. Casing 130 surrounds tubing 140. As the rod 145 reciprocates up and down, the magnets 155 pass back and forth across the coils 160 energizing electrons and creating heating of the coils 160. Heat transfer occurs from the coils 160 to the tubing 140 and to the fluids 150 that are moving through the tubing 140. System 100 can include other common components in an oil well such as the polish rod 125, piping 135, walking beam 110, gearing 115, prime mover 120, plunger 170, and barrel 180. Fluids 150 are pulled into the pipe and flow upward. Fluids 150 can move in directions indicated by fluid arrows 150, and can include water, oil and other substances.

Several variables can be considered when determining the amount of heating needed to eliminate paraffin precipitation. These can include fluid velocity, heat generated, cloud point of paraffin (target temperature), depth of cloud point and distance to surface, fluid properties, and others. Because of the dynamic nature of these variables, every well and every installation will be unique depending upon well variables. Well production and fluid properties are also constantly in flux. Therefore, an embodiment under the present disclosure may need to be adjusted to various circumstances depending on well type, materials, and other factors. Some wells and pumps incorporating the present disclosure may be able to adjust certain factors during operation, such as pump speed, location of the rod, relative location of magnets and coils/bands, material composition in the well, and other factors.

FIG. 1 displays a possible embodiment of the placement of magnets and coils. Other embodiments can comprise a variety of setups. Location, number, size, distance between, material, and other properties of coils can be varied. Location, number, size, distance between, material, and other properties of magnets can be varied. Some embodiments may use cladding instead of coils. In such embodiments, the casing or tubing can comprise cladded sections, such as in copper. Cladded embodiments can achieve similar current generation as coiled embodiments.

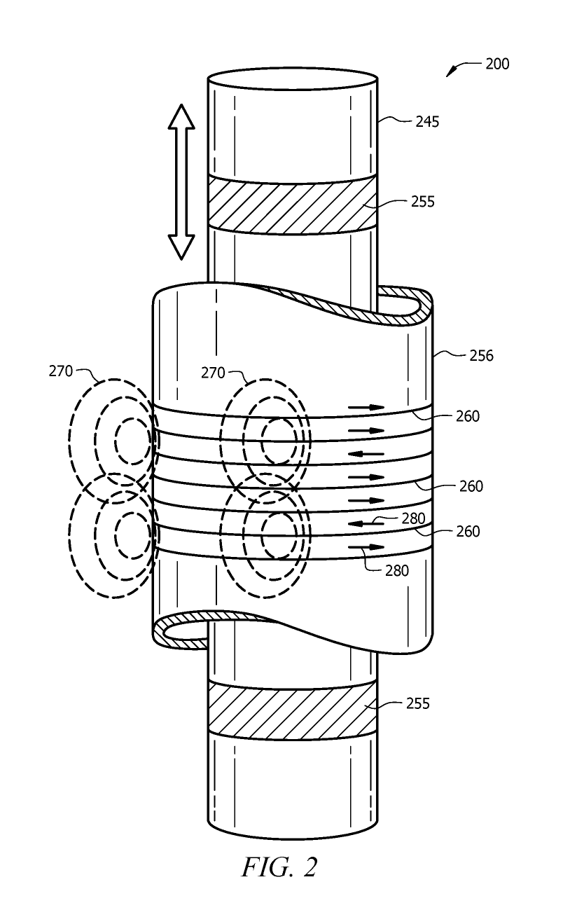

FIG. 2 displays an embodiment of the downhole portion of a pump 200 under the present disclosure. This embodiment comprises coils 258. Rod string 245 extends downward in a pump system 200. Magnets 255 are embedded into the rod string 245 or located on or within rod string 245. Tubing 256 surrounds the rod string 245. Casing (not shown) will surround the tubing 256. Oil, water, other fluids, and particulate matter may be travelling up or down next to the rod string 245 or on either side of tubing 256. As rod string moves up and down during the pumping process, magnetic fields 270 pass through coils 260 creating electrical current 280 which travels back and forth within the coils 260 during interactions with various magnets 255. Resistance to the electrical current 280 produces heat which causes the temperature of the coils 260 and casing to rise. The heat is transferred to the oil, water, or other matter flowing within the pump, raising their temperature. The raised temperature helps to inhibit the precipitation of paraffin.

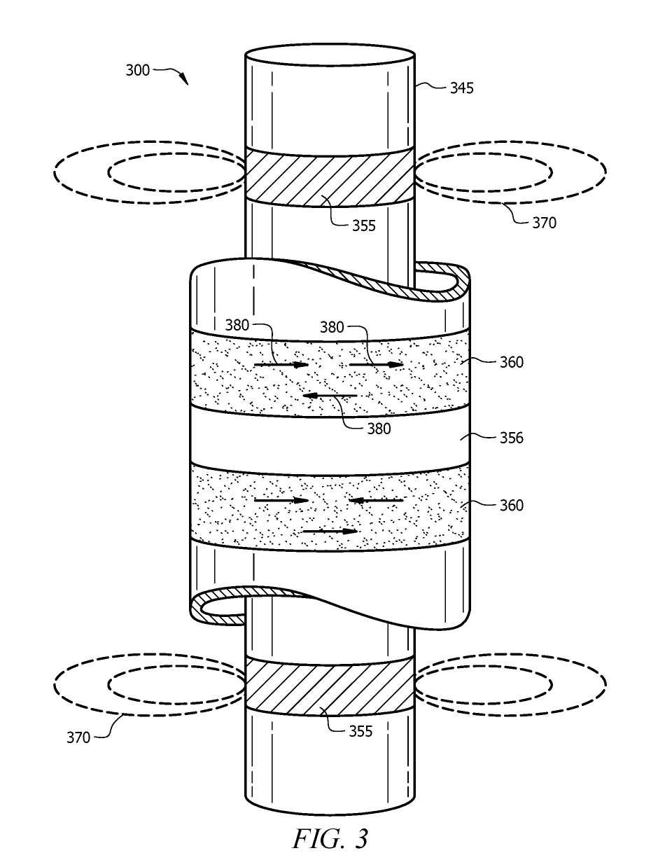

FIG. 3 displays a preferred embodiment of the present disclosure. While not the only effective embodiment, embodiment 300 has proved to be the most useful solution to avoid paraffin precipitation. Embodiment 300 comprises the downhole portion of a pump and includes cladding 360 on the tubing 370. In the embodiment shown, cladding 360 is intended to be on the interior of the tubing 370. Other embodiments could comprise cladding within the interior of the tube material, or on the outward facing surface. As rod string 345 goes up and down during operation, magnets 355 pass through sections of tubing 356 with cladding 360. Cladding 360 (copper in a preferred embodiment, though other materials can be used) is on the outside of tubing 356 (or embedded within). As magnets 355 pass through or near cladding 360 the magnetic fields 370 induce electrical eddy currents 380 within cladding 360. Electrical current 380 causes the temperature of the cladding 360 to rise, thus raising the temperature of oil, water, or other matter flowing within the pump. The raised temperature helps to inhibit the precipitation of paraffin.

In preferred embodiments, the coil or cladding is copper. Other embodiments can use other metals such as aluminum, iron, nickel or cobalt, or other materials as desired by a user. The magnets can comprise a variety of magnetic materials. Examples can include neodymium-iron-boron, iron, nickel, cobalt, some alloys of rare earth metals, and some naturally occurring minerals such as lodestone, and other materials. Coils, magnets, and cladding can be separated by large or small distances on the rod string or tubing. Or the coils, magnets and cladding can be disposed in one central location such that essentially one magnet passes one coil/cladding during operation. Coils/cladding and magnets can also be dispersed throughout the entire tubing and rod string. A variety of layouts can be envisioned under the present disclosure. In the preferred embodiment of FIG. 3 with copper cladding 300, a coating of nickel can also be applied to the copper, providing corrosion resistance. Other types of coatings can be used besides nickel. If copper is not used, aluminum is also an effective cladding material. As stated above, other materials can be used as well.

Some embodiments of the present disclosure can comprise a single magnet that passes through multiple bands or coils during well operation. Other embodiments can comprise multiple magnets that pass through a single coil, set of coils, or band. In some embodiments the magnets and/or coils and bands may be clustered around certain areas in a well where a user wishes to raise the temperature of the well fluids. Other embodiments may comprise magnets and coils/bands along a large portion of a well's depth.

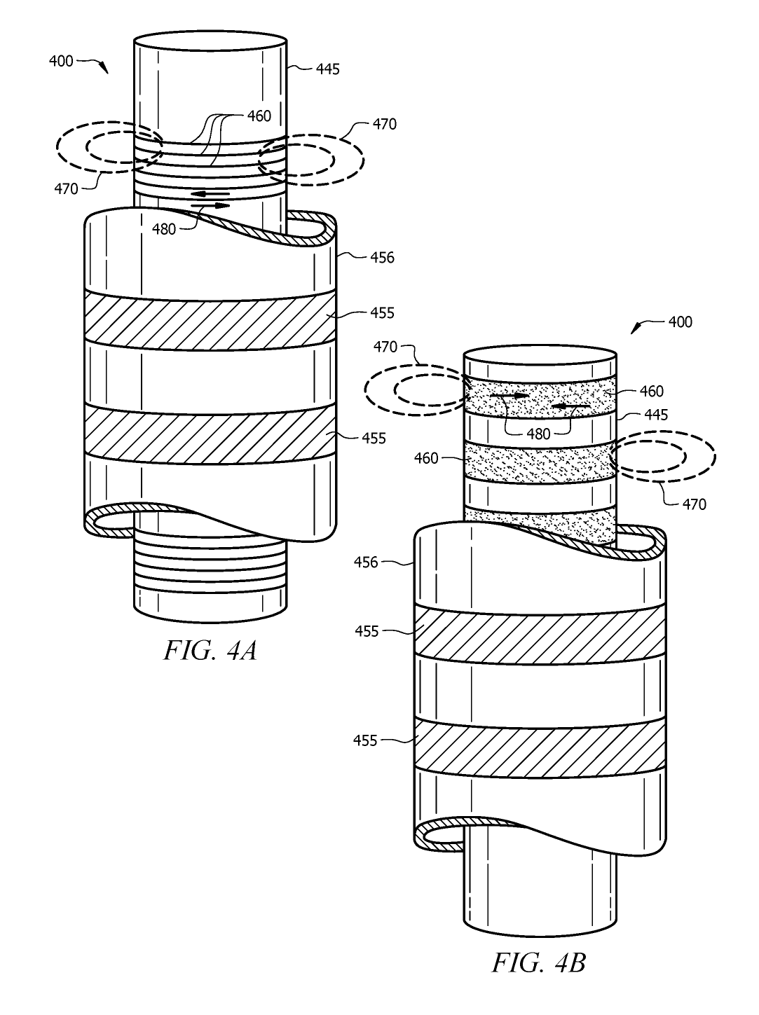

Other possible embodiments of the present disclosure can comprise magnets in the casing and coils/cladding on the rod. Such an embodiment can be seen in FIGS. 4A and 4B. In FIG. 4A, coils 460 are located in rod 445. Magnets 455 are located in the casing 456. As the rod 445 goes up and down electrical fields 470 and currents 480 are created, similar to the embodiments of FIGS. 1-3, except the location of the coils 460 and magnets 455 have been reversed (in comparison to FIG. 2). Similarly, in FIG. 4B, cladding 460 is disposed on the rod 445 and magnets 455 are located in the casing. As rod 445 goes up and down the fields 470 are created, leading to eddy currents 480. Similar to other embodiments, the induced current 480 of FIGS. 4A-4B meet with resistance in the cladding or coil material, leading to heat that is transferred to oil, water, and other materials in the well.

What type of magnet, size, and type and size of coil or cladding can depend on a number of factors. These can include fluid velocity, heat generated, cloud point of paraffin (target temperature), depth of cloud point and distance to surface, fluid properties, rod string size, tubing size, and others. These factors can be taken into consideration when determining how much heat is needed. Below is given one example of how various factors can be combined to determine what types of magnets or cladding to utilize. This is just one example and other situations, with varied factors, will yield different heating, magnetic and cladding/coil needs.

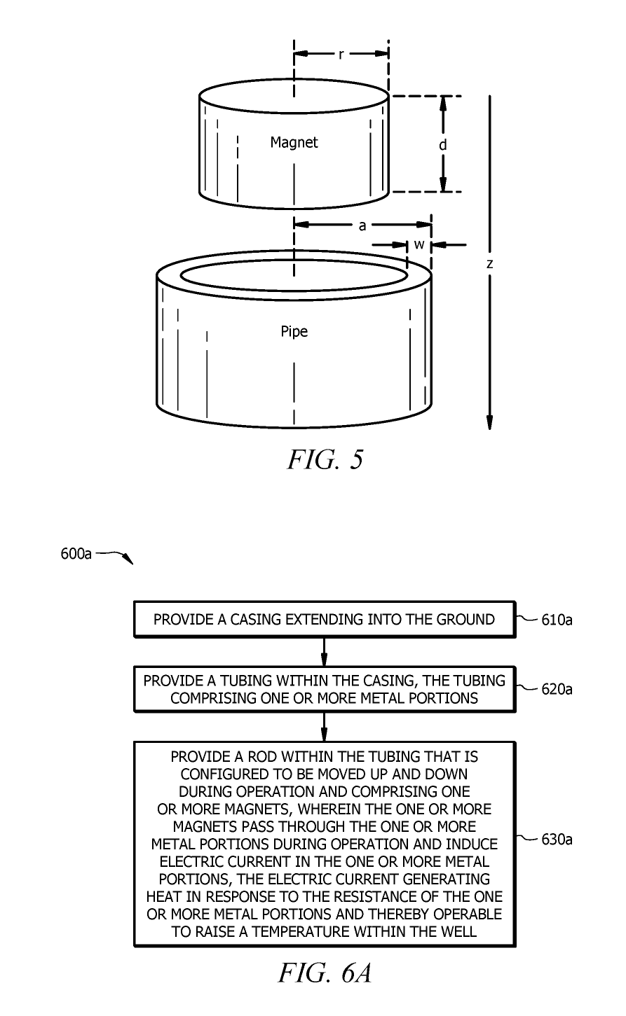

To illustrate one possible embodiment, let us assume the following values, which can be applied to an embodiment such as that shown in FIG. 5:

| | |
|---|---|
| Sucker rod length: 25 ft. | Speed: 8 strokes per minute |
| Stroke length: 150 in. | Tubing diameter: 2.5 in. ID (.063 m) |
| Tubing wall thickness: 0.1875 in | Copper cladding: 0.10 in (.00254 m) |
| (.00476 m) | |
| Rod diameter: 1 in | Oil density: 7.35 lbs/gal |
| Water cut: 50% | Saltwater density: 8.55 lbs/gal |
| Oil specific heat: 0.51 Btu/lb ° F. | Water specific heat: 0.938 Btu/lb ° F. |
| Resistivity of Copper: | |
| 1.68 × 10⁻⁸ Ω-m | |

We can also assume that the goal is to raise the temperature of the oil by 5-10° F. and that the oil is being pumped out at a rate of 40 barrels per day. Assuming that the pumping is continuous then the rate of flow will be 70 gallons per hour. This means that the rate of heat energy input to raise the temperature by 5° F. is:

Qₒᵢₗ=cₚmΔT=(0.51)(7.35)(35)(5)=656 Btu/hr

Q_{water}=cₚmΔT=(0.938)(8.55)(35)(5)=1403.5 Btu/hr

The total heating rate is 2059.5 Btu/hr, or roughly 603 Watts. Electromagnetic induction is a function of the rate of change of flux linkages which in our case is related to the velocity of the magnets attached to the rods. The pump action pulls the rods up and allows them to fall in a periodic fashion which we can assume to be sinusoidal based on the movement of the crank arm. Since this embodiment assumes a 150 inch stroke, the displacement of any point on any rod may be expressed as:

x(t)=x₀+75 sin(ωt) inches

Where x₀ is any arbitrary starting point.

The velocity v is the first derivative of displacement.

dx/dt=75ω cos(ωt) in/sec=62.8 cos(ωt) in/sec

The current required to heat the pipe is assumed to flow through the 0.1 in thick copper cladding on the stainless steel tube with a 3/16 in wall. By modeling the copper tube as a stack of individual rings with diameter a, thickness w, and length the resistance may be calculated as:

R=(2πap)/wl

Calculating the magnetic flux produced by a cylindrical magnet requires approximations to avoid complex calculations. A method introduced by Levin et al may be used here. The first step is to consider the magnet has a uniform magnetization, M=Mz and modeling it as two disks (top and bottom) with a charge density σₘ=M and −σₘ=−M each with a radius r and a separation distance d. This may be further approximated by replacing the disks with point monopoles of the same net charge qₘ=πr²σ_{M}. The flux through a ring produced by the two monopoles may now be easily expressed as:

$$Φ ( z ) = \frac{{μ}_{0 {q}_{M}}}{2} [ \frac{z + d}{\sqrt{{( z + d )}^{2} + {a}^{2}}} - \frac{z}{\sqrt{{z}^{2} + {a}^{2}}} ]$$

Where μ₀ is the permeability of free space and z is the distance from the nearest monopole to the center of the ring. As the magnet moves through the ring at velocity ν, it produces a changing flux which results in electromotive force, ε, given by Faraday's law:

$$ɛ ( z ) = - \frac{d Φ ( z )}{dt} = \frac{{λ}_{0} {q}_{m} {a}^{2} v}{2} [ \frac{1}{{( {z}^{2} + {a}^{2} )}^{3 \text{/} 2}} - \frac{1}{{[ {( z + d )}^{2} + {a}^{2} ]}^{3 \text{/} 2}} ]$$

The power is the square of the voltage divided by the resistance and integrated over the length of the magnet assuming that most of the power dissipation occurs near the magnet:

$$P = \frac{{μ}_{0}^{2} {q}_{m}^{2} {v}^{2} w}{8 πρ {a}^{2}} f ( \frac{d}{a} )$$

Where f(x) is a scaling function based on the dimensions of the magnet and the tube:

$$f ( x ) = {\int }_{- ∞}^{∞} {dy [ \frac{1}{{( {y}^{2} + 1 )}^{\frac{3}{2}}} - \frac{1}{{[ {( y + x )}^{2} + 1 ]}^{\frac{3}{2}}} ]}^{2} .$$

From this information, we can rearrange the equation to solve for the monopole magnetization necessary to generate the power required:

$${q}_{m} = \sqrt{\frac{P 8 πρ {a}^{2}}{{μ}_{0}^{2} {v}^{2} wf ( \frac{d}{a} )}}$$

Magnets are specified in Teslas. To determine the rating of a cylindrical magnet of length d and radius r the value of qₘ needs to be back calculated:

$$B = \frac{{q}_{m} {μ}_{0} d}{2 π {r}^{2} \sqrt{{d}^{2} + {r}^{2}}}$$

For a reference calculation using our defined parameters, the velocity needs to be expressed as the RMS value of 0.707*62.8 in/sec=1.127 m/s. Using an arbitrary cylindrical magnet of 0.5-in length and 0.25-inch diameter the value of qₘ is 2.316×10⁴ and using the back calculation for B we need a magnet with a surface magnetization of 445.7 Teslas. This is a huge number but it is for a single small magnet. If we substitute the equation for B vs qₘ into the original power calculation, we can calculate the power associated with any magnet:

$$P = \frac{{B}^{2} π {r}^{4} {v}^{2} w ( {d}^{2} + {r}^{2} )}{2 πρ {a}^{2} {d}^{2}} f ( \frac{d}{a} ) .$$

Using the large diameter sucker rod and tube with clearance we can fashion a magnet that is 1.75 inches in diameter and 0.5-in thick with a 1-in hole in the middle.

Some of the strongest magnets available are made from neodymium-iron-boron and have a surface field in the range of 0.4 to 0.7 T (4000-7000 Gauss). Using the principle of superposition, we can calculate the power generated by a solid magnet of 1.75-in diameter and subtract from it the power generated by a magnet 1-in in diameter. The calculated power is 15.45 W for one magnet. It would take 39 magnets to supply the approximately 603 W required. With the recent discovery that placing magnets with poles opposed can double the Lenz effect, about 31 W per magnet may be obtained. In the possible embodiment described, that would require only 20 magnets to do the job.

The foregoing calculations illustrate just one possible embodiment under the present disclosure. Numerous factors can impact the above calculations for a given embodiment. Air and water content within a pipe, or around the tubing and casing, can have impacts, for example. If there is mostly air between the tubing and casing, then most heat generated by the magnets will flow into the oil. But if oil, water, or other substances take up space between the tubing and casing then these substances may provide another route for heat to flow. In such situations more magnets may be required. Also, any water cut will increase the specific heat of the mix and require more heat to raise the temperature.

Since the magnets may be in a form where they slide down the sucker rod, they can self-locate by mutual repulsion even when pushed together. In the calculated embodiment above the maximum density of magnets would be about one magnet per inch with about 18 pounds of force required to hold the stack together. This would allow up to 144 magnets within a 150-in stroke. This would be enough for 4.5 kW of power—enough to raise the temperature by 37 F. Increasing the thickness of the copper from 0.1-in to 0.125-in increases the power by 25%.

In other embodiments the magnets can be assembled on the sucker rod with guides and held by threaded collars then coated with epoxy or rubber paint to protect and cushion them. The guides can prevent magnets from sticking the rod to the carbon steel tubing when assembling.

In a preferred embodiment the sucker rods can be made from non-magnetic material, such as stainless steel. The tubing in the vicinity of the magnets can also be non-magnetic and also have low volume resistivity. One way to achieve this could be by cladding a stainless steel tube with copper which would then be nickel plated.

FIG. 5 displays a possible embodiment of a method 500 under the present disclosure. At 510, a casing is provided extending into the ground. At 520, a tubing is provided within the casing, the tubing comprising one or more metal portions extending around the tubing. At 530, a rod is provided within the tubing that is configured to be moved up and down during operation of the well, the rod comprising one or more magnets, wherein the one or more magnets pass through the one or more metal portions during operation of the well and induce an electric current in the one or more metal portions, the electric current operable to raise a temperature within the well. The metal portions can comprise coils or bands, or other configurations of metal portions in which an electrical current can be induced. A preferred embodiment comprises copper bands or wires, but other materials and configurations can be used.

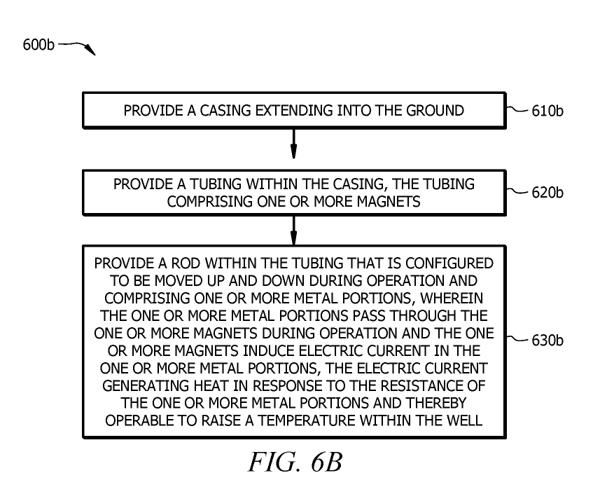

FIGS. 6A-6B display several possible method embodiments for constructing a drilling and pumping system under the present disclosure. Method 600a shows a method for making a system with metal portions in a tubing and magnets in a rod. Method 600b shows a method for making a system with magnets in a tubing and metal portions in a rod. In process 600a, at step 610a a casing is provided for the drilling well. At 620a, a tubing is provided within the casing, the tubing comprising one or more metal portions. At 630a, a rod is provided within the tubing that is configured to be moved up and down during operation and comprising one or more magnets, wherein the one or more magnets pass through the one or more metal portions during operation and induce electric current in the one or more metal portions, the electric current generating heat in response to the resistance of the one or more metal portions and thereby operable to raise a temperature within the well.

Process 600b is similar to 600a, but the placement of magnets and metal portions is reversed. At 610b, a casing is provided extending into the ground. At 620b, a tubing is provided within the casing, the tubing comprising one or more magnets. At 630b, a rod is provided within the tubing that is configured to be moved up and down during operation and comprising one or more metal portions, wherein the one or more metal portions pass through the one or more magnets during operation and the one or more magnets induce electric current in the one or more metal portions, the electric current generating heat in response to the resistance of the one or more metal portions and thereby operable to raise a temperature within the well.

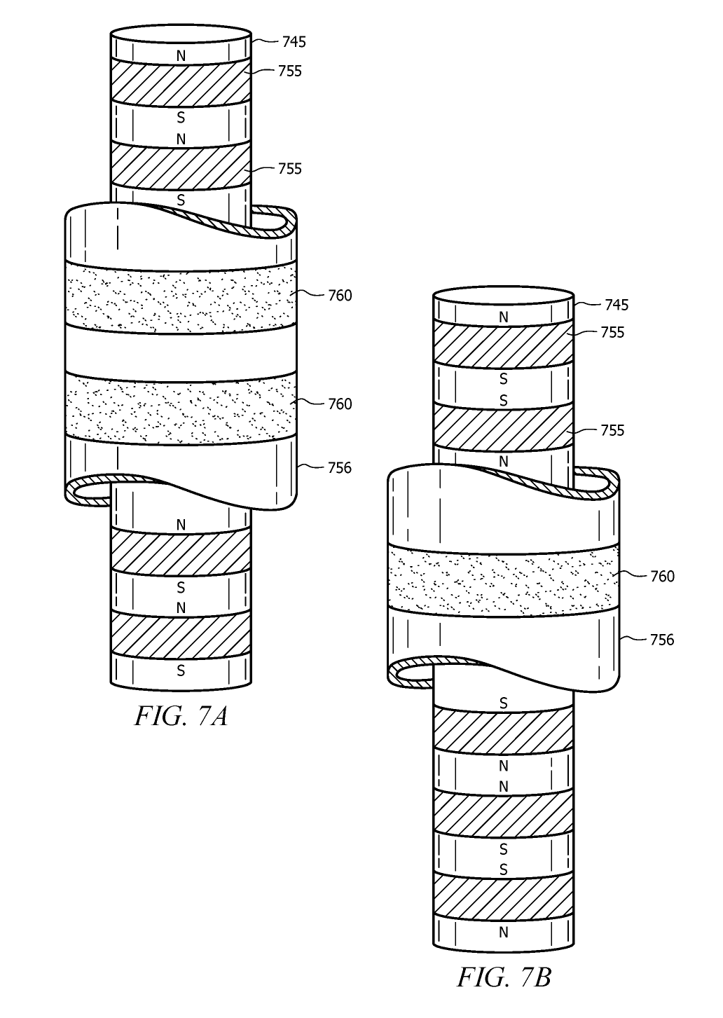

The polarity of magnets used, either in the rod or the tubing, is a variable that can be adjusted in different embodiments. FIGS. 7A-7B show several such examples. FIGS. 7A-7B show downhole rod portions 700 similar to those of other embodiments. Rod 745 comprises magnets 755. Tubing 756 comprises copper cladding 760. In FIG. 7A the magnets 755 are arranged with north N facing up and south S facing down on each magnet 755. FIG. 7B shows a rod 745 and tubing 756 with a different setup. Here, polarities are reversed on each magnet 755. The top magnet shown goes N-S (from top to bottom), the next magnet is S-N, and so forth. Any arrangement of polarities is within the teachings of the present disclosure. FIG. 7A can comprise a “normal polarity.” FIG. 7B can comprise a “reversed polarity.” It has been found that, in many embodiments, a reversed polarity setup helps to create more heat. Combinations are also possible. For instance, a rod 745 may be arranged with normal polarity for a certain length, followed by a second length with reversed polarity. A rod 745 can switch back and forth. Other embodiments of variously arranged magnetic polarity can comprise coils instead of cladding. In addition, some embodiments may comprises magnets in the tubing and coils/cladding in the rod. The teachings of FIGS. 7A and 7B regarding reversing polarity can be applied to embodiments with magnets in the tubing, coils/cladding in the rod, and in various embodiments of varying materials, sizes, geometries, and so forth.

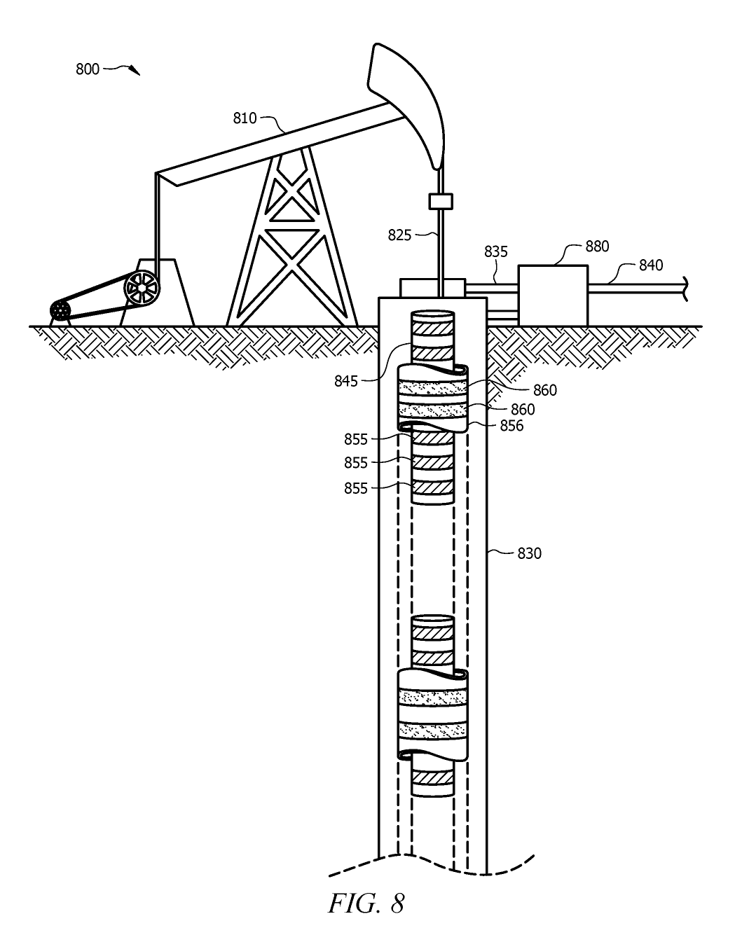

The teachings of the present disclosure can also help improve oil drilling functionality and efficiency in colder climates. When drilling in cold climates there may be a need not just to inhibit paraffin precipitation, but also to raise the temperature of liquids (oil, water, etc) for transport from a drill to another location. It is common for drilling operations to construct heat exchangers or heaters at the surface of a drill. These heaters serve to heat the liquids being pumped from the well so that they do not freeze and are easily transportable by a pipeline to a factory, storage tank or other facility. Under the present disclosure, magnets and coils/cladding can help heat the liquids and even allow the removal of surface heat exchangers and heaters. FIG. 8 shows an embodiment including magnets and coils that can be helpful in cold climates. Drill 800 comprises drill equipment 810, rod string 825, rod 845, tubing 856, and casing 830. Pumped liquids flow through piping 835 to a machinery 880 and then piping 890 for delivery to storage tanks, factories, or elsewhere. Rod 845 comprises magnet 855 and tubing 856 comprises copper cladding 860. Magnets 855 and cladding 860 can be disposed near the surface so that substances being pumped are kept at a high enough temperature to avoid any freezing or pumping difficulty. Magnets 855 and cladding 860 disposed further down in the well may provide help in avoiding paraffin precipitation. However, all magnets and cladding/coils within the well may serve to avoid precipitation of paraffin and/or help to warm pumped materials for transport. One embodiment can comprise a plurality of magnets and cladding/coils near the surface of the drill to warm materials for transport, and another plurality of magnets and coils further down the well to help inhibit paraffin precipitation. However, a variety of embodiments are possible, with magnets and coils/cladding placed at numerous locations within the well. Machinery 880 may provide any pumping machinery or other components necessary to assist in the pump functionality. Because system 800 warms up pumped materials via the interaction of magnets 855 and cladding 860, machinery 800 does not need to include any heater or heat exchanger for heating the pumped materials for transport. System 800 can therefore avoid any maintenance, power costs, or other factors associated with maintaining a heater or heat exchanger at the surface of the drill.

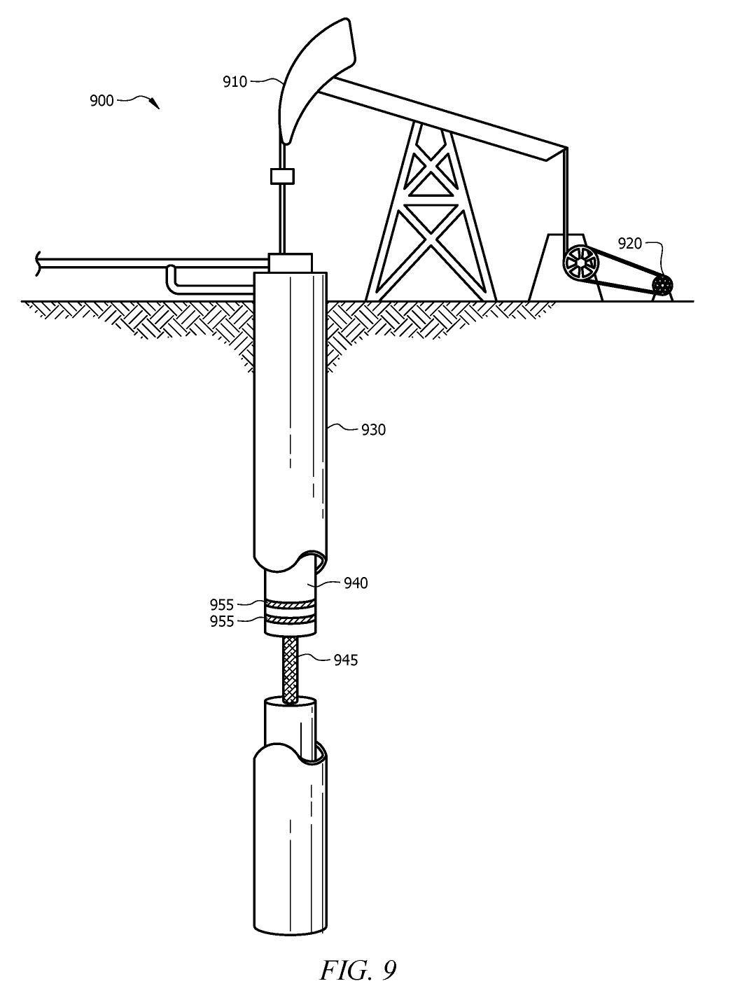

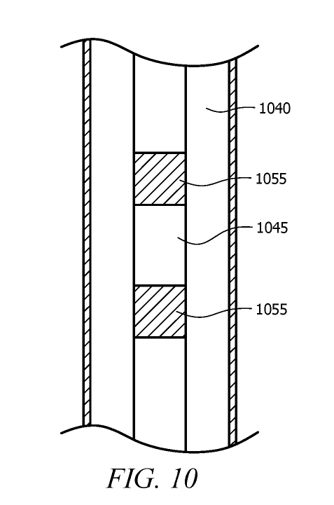

Further possible embodiments under the present disclosure can comprise magnets that induce current in a rod, rotor, or other component, by virtue of the conductive properties of the material comprising the rod, rotor, or other component. In such embodiments additional coils or cladding are not needed. Such an embodiment can be seen in FIG. 9. System 900 can include common components in an oil well such as the polish rod 925, piping 935, walking beam 910, gearing 915, and prime mover 920. Embodiment 900 includes a casing 930, rod 945, and tubing 940. In this case the tubing comprises magnets 955. In this embodiment the rod is comprised of a conductive material, such as copper, aluminum, iron, nickel or cobalt, or other materials as desired by a user. As rod 945 goes up and down it passes through magnets 955, and eddy currents are induced within rod 945. Resistance to the electrical current produces heat which causes the temperature of the rod 945 or tubing 940 to rise. The heat is transferred to the oil, water, or other matter flowing within the pump, raising their temperature. The raised temperature helps to inhibit the precipitation of paraffin. FIG. 10 shows another possible embodiment that uses magnets without cladding or coils. In FIG. 10 the magnets 1055 are placed within or on the rod 1045. Tubing 1040 can comprise copper or aluminum, or other materials such as discussed above. As rod 1045 goes up and down the magnets 1055 will induce current in tubing 1040.

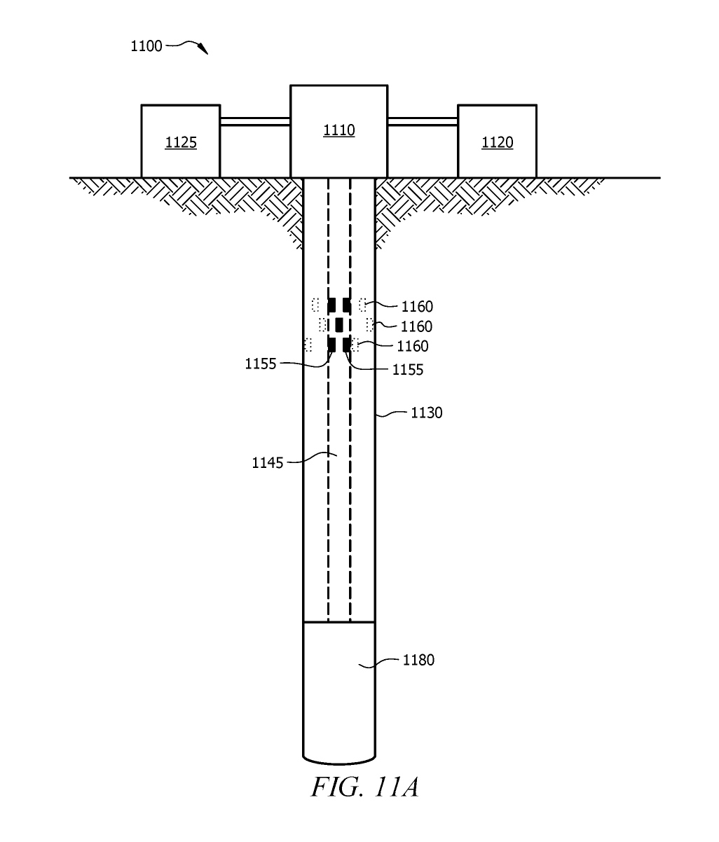

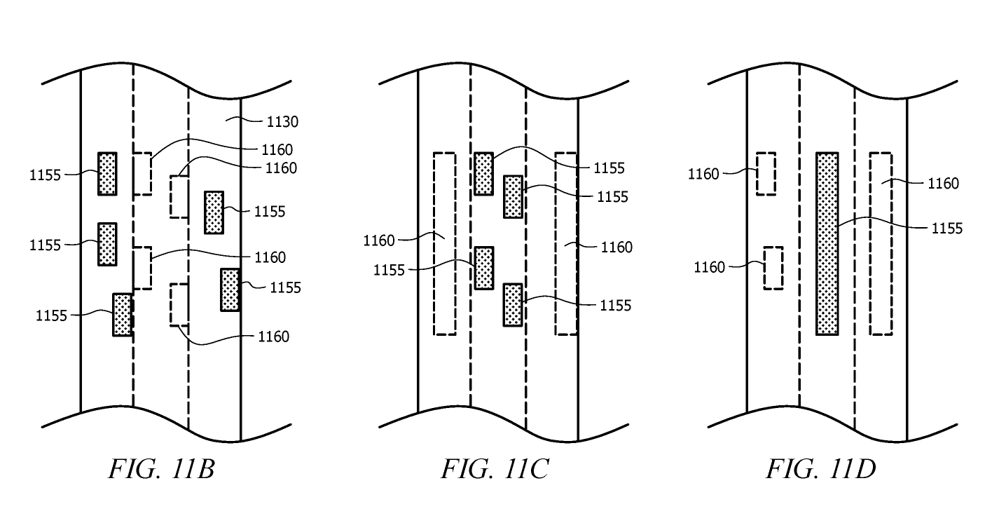

FIG. 11A displays an embodiment 1100 of the present disclosure incorporating a progressive cavity pump 1180. Pump 1100 can comprise surface units 1110, power supply 1120, collector 1125, and other components typically found at the surface of progressive cavity pumps. Casing 1130 can encase the downhole portion of the pump 1100 and rod 1145. Progressive cavity pump 1180 can comprise any type of progressive cavity pump and typical components such as a stator and rotor. Above progressive cavity pump 1180, where paraffin may precipitate, rod 1145 can comprise magnets 1155. Near magnets 1155, cladding or plates 1160 can be incorporated into the casing 1130. As rod 1145 spins the magnets 1155 will pass by cladding 1160, and eddy currents are induced within cladding 1160. Resistance to the electrical current produces heat which causes the temperature of the casing 1130 to rise. The heat is transferred to the oil, water, or other matter flowing within the pump, raising their temperature. The raised temperature helps to inhibit the precipitation of paraffin, make the material easier to pump, or lower the viscosity of the material.

The placement, shape, geometry, and other characteristics of magnets 1155 and cladding 1160 in embodiment 1100 can vary. Several different variations are shown in FIGS. 11B-11D. In FIG. 11B magnets 1155 are located in the casing 1130 while cladding 1160 is on the rod 1145. In FIG. 11C long cladding portions 1160 extend past multiple magnets 1155 on rod 1145. In FIG. 11D there are long magnets 1155 and long cladding 1160, as well as shorter cladding 1160. Variously sized magnets 1155 and cladding 1160 can be combined in a single embodiment. Magnets 1155 and cladding 1160 will generally be spaced about the perimeter or interior of rod 1145 or casing 1130, or integrated within rod 1145 or casing 1130. The spacing between cladding 1160 on the casing 1130, for example, can be random, or at set intervals, such as 10 cm. Spacing between elements on rod 1145 or casing 1130 can be random or at set intervals. Casing 1130 or rod 1145 could comprise only a single magnet 1155 or cladding 1160. Magnets 1155 and cladding 1160 can be placed at irregular angles to a perpendicular or horizontal plane. Magnets 1155 and cladding 1160 can be located on the rod 1145 or casing 1130 and can be disposed vertically, horizontally, angled, extending all the way around the rod 1145 or casing 1130, or in any arrangement.

Elements of a progressive cavity pump, such as that shown in FIG. 11A, can be combined with other embodiments described herein. The embodiment 1100 can comprise magnets of reversing or mixed polarity, such as described above in relation to other embodiments. As discussed in other embodiments, cladding 1160 can comprise copper, aluminum, or a variety of other materials. The magnets can comprise a variety of magnetic materials. Examples can include neodymium-iron-boron, iron, nickel, cobalt, some alloys of rare earth metals, and some naturally occurring minerals such as lodestone, and other materials.

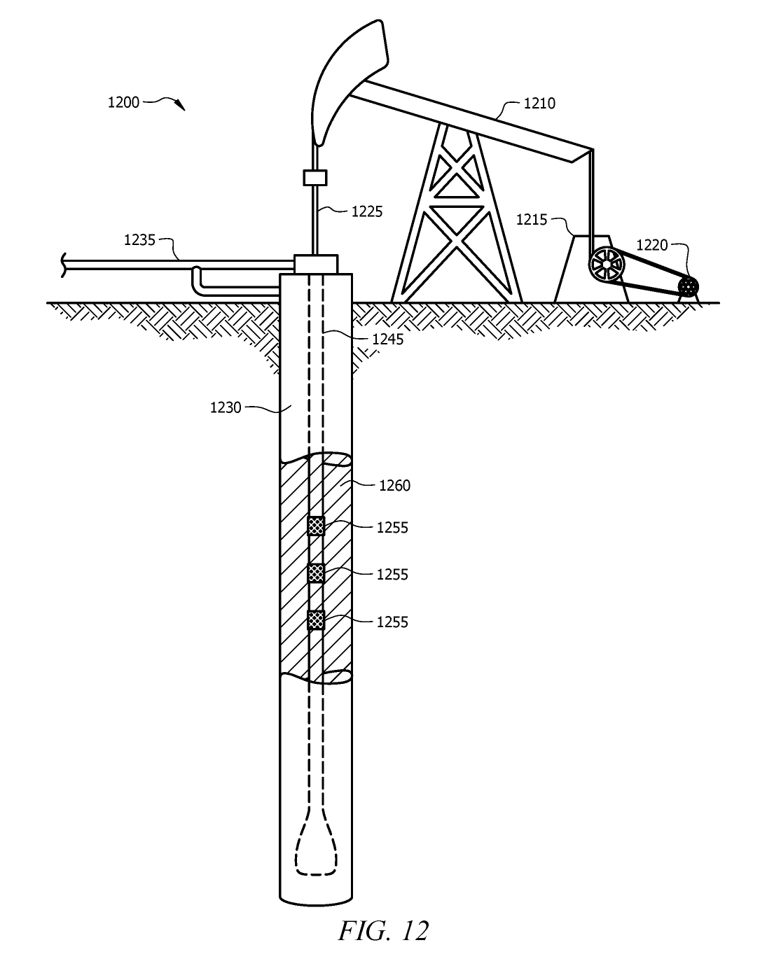

A further embodiment under the present disclosure can comprise long portions of copper plating or tubing within a casing of a pump. Such an embodiment can be seen in FIG. 12. Pump 1200 can resemble the embodiment of FIG. 1, though it could be a progressive cavity pump or other type of pump as desired. Casing 1230 surrounds the downhole portion of pump 1200, including the rod 1245. Magnets 1255 can be placed at various locations along rod 1245. Inductive tube 1260 resides within casing 1230 and extends for a given distance. In a preferred embodiment the inductive tube is between 10 and 15 feet long. However, it can be shorter or longer. Multiple inductive tubes can be included within a single pump. As rod 1245 reciprocates up and down the magnets 1255 can induce current within inductive tube 1260. Resistance to the electrical current produces heat which causes the temperature of the inductive tube 1260 to rise. The heat is transferred to the oil, water, or other matter flowing within the pump, raising their temperature. The raised temperature helps to inhibit the precipitation of paraffin. In a preferred embodiment the inductive tube 1260 comprises copper. However, other embodiments can comprise aluminum or other materials.

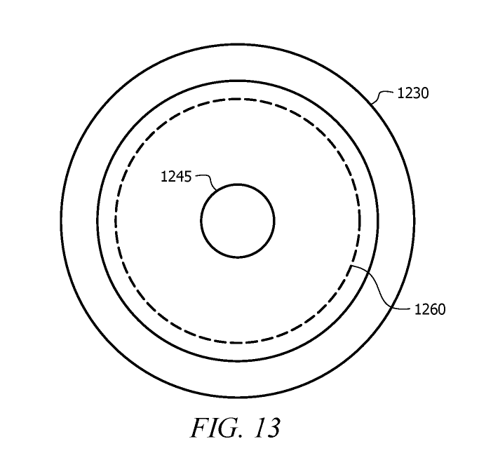

FIG. 13 displays the embodiment of FIG. 12 from a top-down perspective. Casing 1230 surrounds inductive tube 1260 and rod 1245. This embodiment can be created by inserting inductive tube 1260 into casing 1230 and then performing a cold or hot fusion procedure to attached inductive tube 1260 to the casing 1230. Any other appropriate joining technique can be used to fix inductive tube 1260 into casing 1230.

Solutions and embodiments under the present disclosure can comprise magnets, coils, cladding, or other structures at any location in the downhole portion of the pump. In certain embodiments it may be preferred to have magnets and coils/cladding/tubes near the surface to inhibit paraffin precipitation, or wherever precipitation is at risk of occurring. Other embodiments may place magnets and coils/cladding/tubes further down. Placing such structures further down in the hole can help with paraffin precipitation and also in lowering the viscosity of pumped materials, making the pumping process easier. Some embodiments may even place magnets and coils/cladding/tubes below a pumping structure. For instance, magnets and coils/cladding/tubes could be placed below a progressive cavity pump. While such an embodiment may or may not have an impact on paraffin, it may help lower the viscosity of the pumped material, making the pumping process easier.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A well for pumping oil, comprising:
a casing disposed underground;
a tubing disposed within the casing and comprising a first plurality of sections comprising a first material; and
a rod disposed within the tubing and comprising a second plurality of sections comprising a second material, the rod configured to be moved up and down during operation of the well, wherein the second plurality of sections pass through the first plurality of sections and induce an electric current in at least one of the first or second materials, the electric current generating heat in response to the resistance of the first or second material thereby raising a temperature within the well.

2. The well of claim 1 wherein the first material comprises copper coils and the second material comprises a magnet.

3. The well of claim 1 wherein the second material comprises copper coils and the first material comprises a magnet g.

4. The well of claim 1 wherein the first material comprises copper cladding and the second material comprises a magnet.

5. The well of claim 1 wherein the first material comprises a magnet and the second material comprises copper cladding.

6. The well of claim 1 wherein the first material comprises metal coils.

7. The well of claim 1 wherein the first material comprises neodymium-iron-boron.

8. The well of claim 1 wherein the second material comprises neodymium-iron-boron.

9. A well for pumping oil, comprising:
a casing disposed underground;
a tubing disposed within the casing and comprising one or more metal bands extending around the tubing; and
a rod disposed within the tubing and comprising one or more magnets, the rod configured to be moved up and down during operation of the well, wherein the one or more magnets pass through the one or more metal bands during operation of the well and induce an electric current in the one or more metal bands, the electric current generating heat in response to the resistance of the metal bands thereby raising a temperature within the well.

10. The well of claim 9 wherein the one or more metal bands are on an interior surface of the tubing.

11. The well of claim 9 wherein the one or more metal bands are on an exterior surface of the tubing.

12. The well of claim 9 wherein the one or more metal bands comprise copper.

13. The well of claim 9 wherein the one or more magnets comprise neodymium-iron-boron.

14. The well of claim 9 wherein the electric current raises a temperature of at least a portion of fluid within the well.

15. The well of claim 9 wherein the one or more metal bands and the one or more magnets are configured to inhibit the formation of paraffin within the well.

16. The well of claim 9 wherein the one or more metal bands and the one or more magnets are configured to prevent oil within the well from reaching a cloud point.

17. A method of constructing an oil well, comprising:
providing a casing extending into the ground;
providing a tubing within the casing, the tubing comprising one or more metal portions extending around the tubing; and
providing a rod within the tubing that is configured to be moved up and down during operation of the well, the rod comprising one or more magnets, wherein the one or more magnets pass through the one or more metal portions during operation of the well and induce an electric current in the one or more metal portions, the electric current generating heat in response to the resistance of the one or more metal portions and thereby operable to raise a temperature within the well.

18. The method of claim 17 wherein the one or more metal portions are disposed on an interior surface of the tubing.

19. The method of claim 17 wherein the one or more metal portions comprise copper wire.

20. The method of claim 17 wherein the one or more metal portions and the one or more magnets are configured to inhibit the formation of paraffin within the well.
